(19) United States
(12) Patent Application Publication
(10) Pub. No.: US 2024/0379028 A1
(43) Pub. Date: Nov. 14, 2024

(54) Interchangeable Custom Covering System

(71) Applicant: Jay Sarkar, Corona, NY (US)

(72) Inventor: Jay Sarkar, Corona, NY (US)

(21) Appl. No.: 18/195,527

(22) Filed: May 10, 2023

(51) Int. Cl. G09F 3/20; A41H 3/00; G09F 3/02

(52) U.S. Cl. CPC G09F 3/203; A41H 3/007; G09F 2003/0282

(57) ABSTRACT

An interchangeable custom covering system (ICCS) for personal items such as caps, backpacks, handbags, watches, footwear, belts and cell phone cases etc. is disclosed. The system is comprised of a transparent, custom-fitted, flexible window that affixes to multiple articles and accessories to display personalized messages and graphics. For example, a user can obtain the customized window, create a team logo, print it out on a card and insert said card into the window affixed to a product such as a baseball cap. Other embodiments can include said cards having a multitude of shapes, sizes, colors, patterns and text thereon that significantly change the appearance of a product.

### CROSS-REFERENCE TO RELATED APPLICATIONS

The present application includes subject matter disclosed in and claims priority to a provisional application entitled “Custom Covering System” filed Feb. 3, 2022 and assigned Application No. 63/306,454 describing an invention made by the present inventor.

### FIELD OF THE INVENTION

The present invention generally relates to customized messaging. More specifically, it relates to an interchangeable system for providing custom messages on various items such as clothing, personal items, and hats etc.

### BACKGROUND

Messaging is an inherent aspect of today's society. Branding and brand loyalty is a billion-dollar-a-year industry as consumers seem to enjoy displaying their interests on their caps, school bags, purses, footwear and belts. Common messaging can include a sports team, a music band and a famous company just to name a few. As messaging and branding continue to grow, new display options for consumers and companies are becoming necessary. In addition, many consumers would prefer a way to customize products so that they can apply their own look and style to said articles. The clothing industry has several patents relating to custom coverings. United States Patent No. US20150071978A1 granted to Alice Chang disclosed a clothing and covering system. Chinese Patent No. CN104188140A discloses a multifunctional clothing covering system United States Patent No. U.S. Pat. No. 4,149,246A granted to Robert N. Goldman disclosed a system for specifying custom garments. However, these patents do not incorporate transparent windows on articles that allow for interchangeable, customized cards to be installed on personal effects.

### SUMMARY OF THE INVENTION

The device herein disclosed and described provides a solution to the shortcomings in the prior art through the disclosure of a custom messaging system. An object of the ICCS is to turn every day, personal items such as caps, school bags, purses, footwear, watches and belts into customized, messaging platforms.

Another object of the ICCS is to provide a means of customizing cards that go over articles. Users can create their own patterns and shapes on cards and insert them into the transparent window and display them.

Another object of the invention is to allow users to generate digital images on their mobile devices and insert them into the window. Another embodiment of the ICCS includes a software application (app) that allows users to customize templates with text and images quickly and print and cut them out with ease.

Another object of the ICCS is to allow items to be used for multiple images over time. For example, on one occasion a hat can display a user's favorite sports team. On another day the hat can display a user's favorite movie character. This feature can also save consumers money instead of purchasing items that are solely-dedicated to a single message-such as a sports team jersey that cannot be altered). Other embodiments can include cards with different colors, shapes, sizes of cards and cards with patterns and colors.

Another object of the ICCS is to provide a means to allow users to affix the custom cards to multiple types of personal effects. The window has one side with an attachment means such as hook and loop etc. that allows it to be place on many common items.

It is briefly noted that upon a reading this disclosure, those skilled in the art will recognize various means for carrying out these intended features of the invention. As such it is to be understood that other methods, applications and systems adapted to the task may be configured to carry out these features and are therefore considered to be within the scope and intent of the present invention, and are anticipated. With respect to the above description, before explaining at least one preferred embodiment of the herein disclosed invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention. As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present.

By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The objects features, and advantages of the present invention, as well as the advantages thereof over existing prior art, which will become apparent from the description to follow, are accomplished by the improvements described in this specification and hereinafter described in the following detailed description which fully discloses the invention, but should not be considered as placing limitations thereon.

### BRIEF DESCRIPTION OF THE FIGURES

The accompanying drawings, which are incorporated herein and form a part of the specification, illustrate some, but not the only or exclusive, examples of embodiments and/or features.

FIG. 1 shows a perspective view of a card and the transparent window on a sandal.

FIG. 2 shows a perspective view of a card and the transparent window on a sneaker.

FIG. 3 shows a perspective view of a card and the transparent window on a hand bag.

FIG. 4 shows a perspective view of a watch with card inserted into the strapping.

FIG. 5 shows a perspective view of a card and the transparent window on a hat.

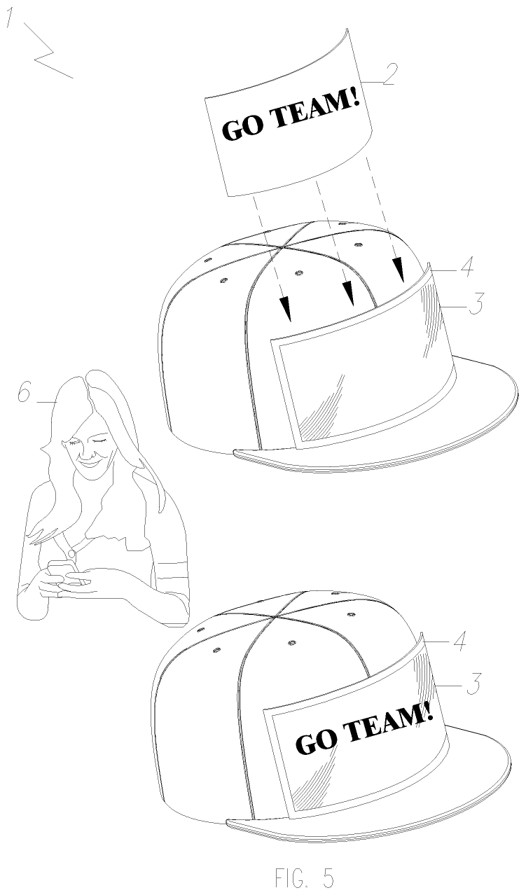

FIG. 6 shows a perspective view of a card and the transparent window on a backpack.

FIG. 7 shows a perspective view of a digital display and the transparent window on a hat.

FIG. 8 shows a perspective view of a belt with card with transparent window.

FIG. 9 shows a representative view of the invention's method.

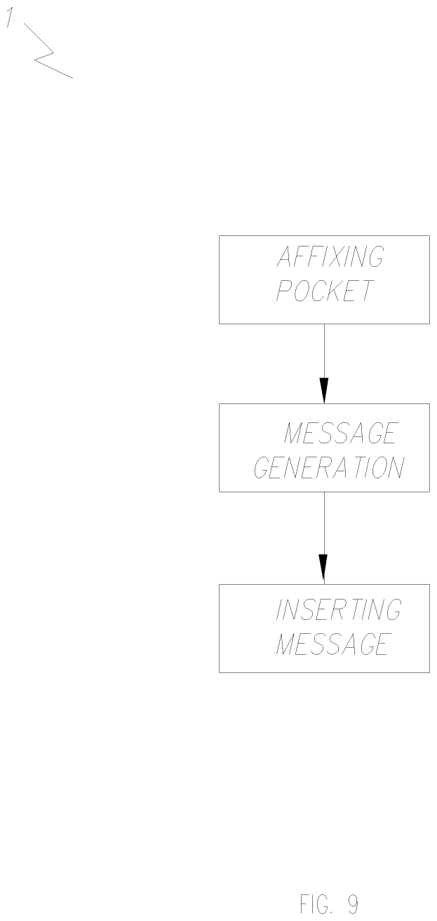

FIG. 10 shows a view of card inserts that can be customized and printed on an ink jet printer.

FIG. 11 shows a view of card inserts onto a cell phone.

Other aspects of the present invention shall be more readily understood when considered in conjunction with the accompanying drawings, and the following detailed description, neither of which should be considered limiting.

### DETAILED DESCRIPTION OF FIGURES

In this description, the directional prepositions of up, upwardly, down, downwardly, front, back, top, upper, bottom, lower, left, right and other such terms refer to the device as it is oriented and appears in the drawings and are used for convenience only; they are not intended to be limiting or to imply that the device has to be used or positioned in any particular orientation. Conventional components of the invention are elements that are well-known in the prior art and will not be discussed in detail for this disclosure.

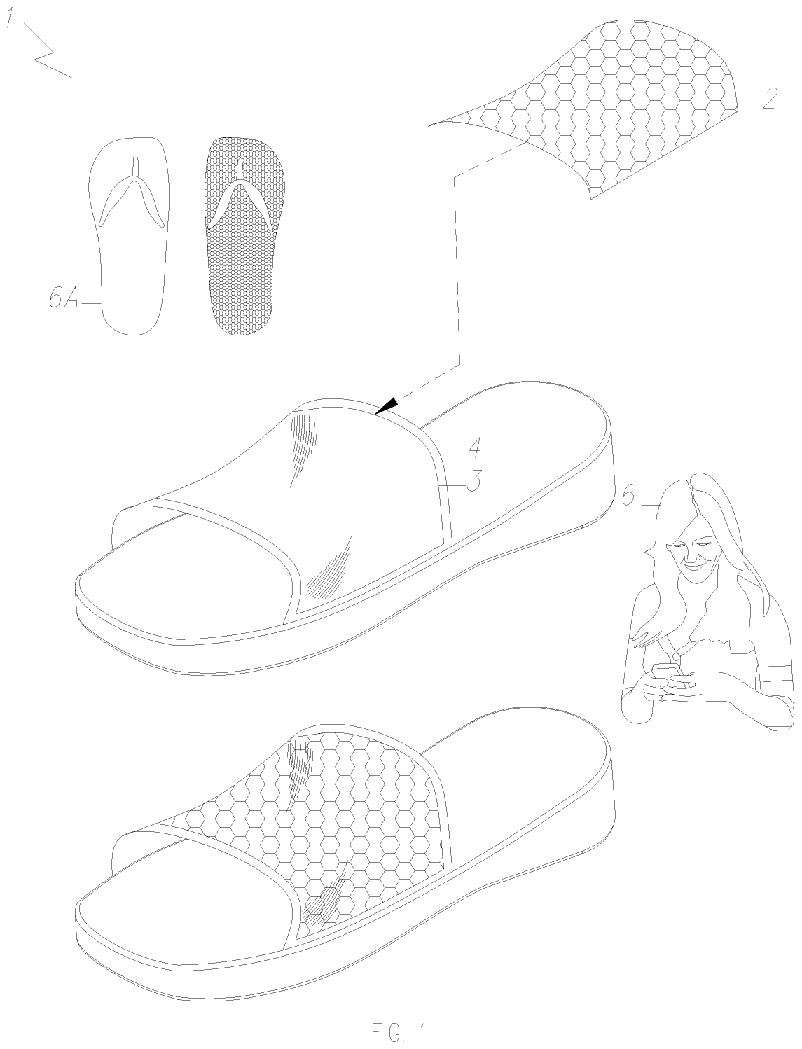

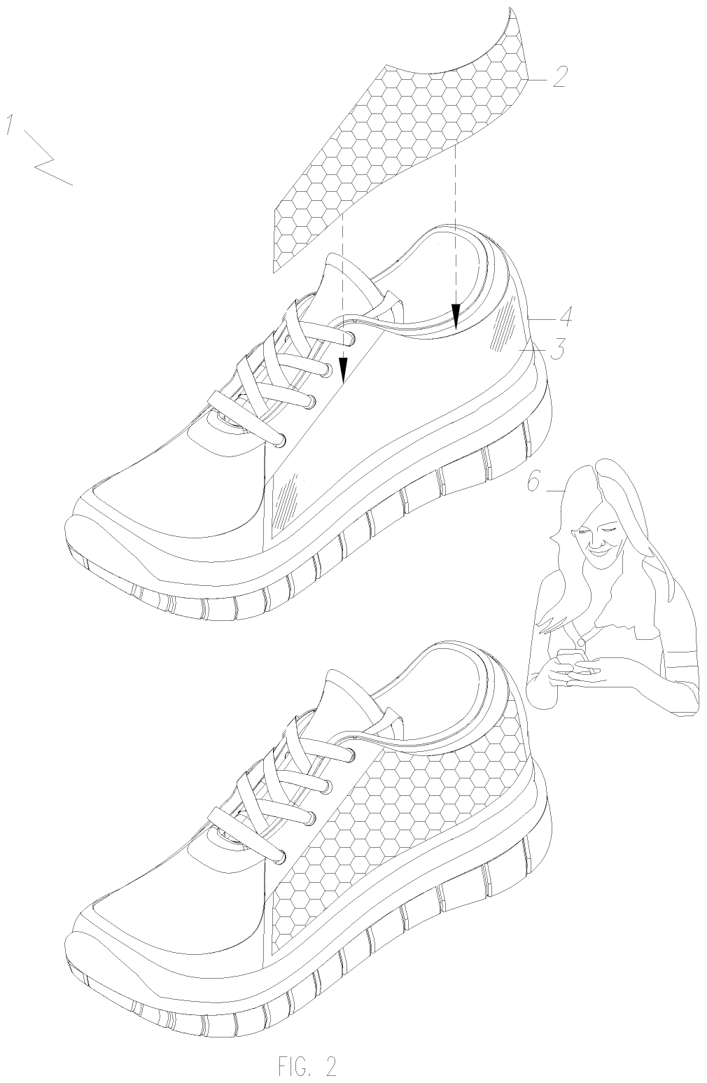

FIGS. 1 and 2 show perspective views of the preferred embodiment of the ICCS 1 being utilized on footwear such as sandals and sneakers. The system having a custom card 2 used as a substrate for applying customized messages and graphics Said ICCS 1 on footwear being comprised of a square-shaped transparent window 3 having at least two walls that are sealed within a flexible frame 4 on at least three distal ends and configured to receive custom card 2 there between. Said FIG. 1 also showing other embodiments of sandals including thong sandals 6A where in the base of the sandal contains the transparent window 3 and a card 2 with new pattern etc. is inserted manually by a user therein. Said transparent window 3 and flexible frame 4 having a plurality of shapes and being made of a plastic such as but not limited to: a low-density polyethylene sheet, high density polyethylene sheet, polyethylene terephthalate plastic, PVC Polyvinyl, and polyester and the like.

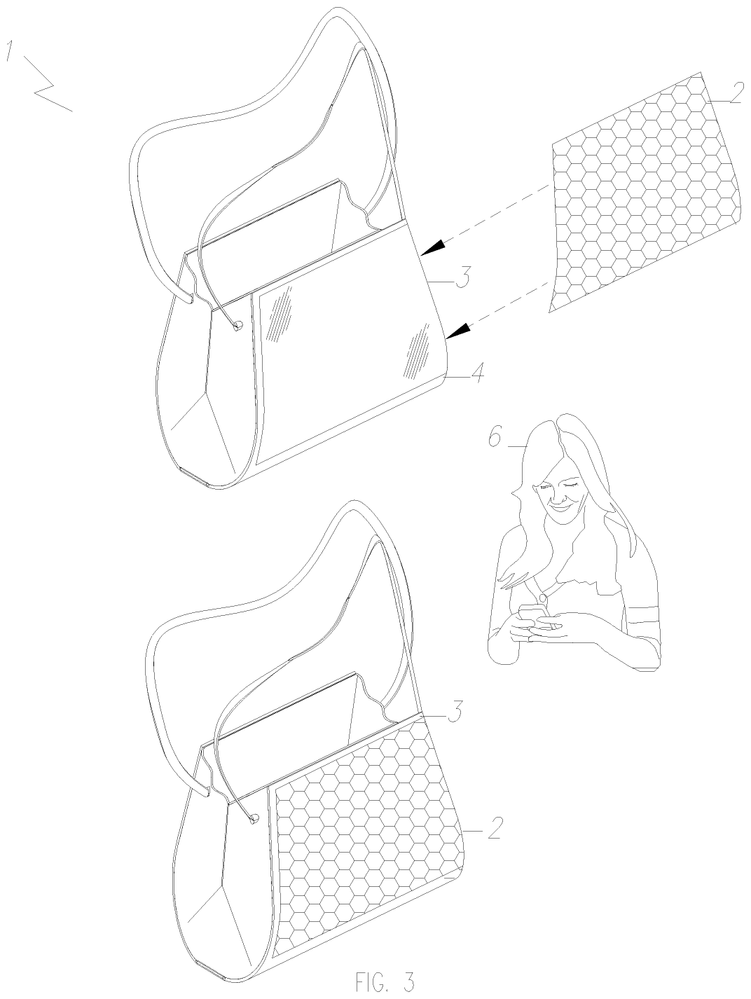

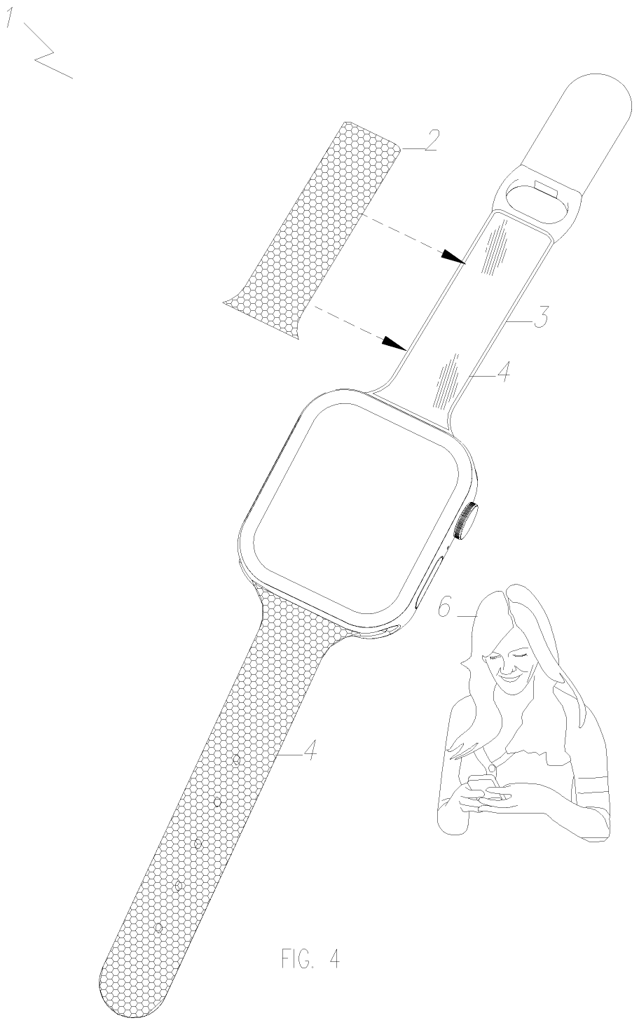

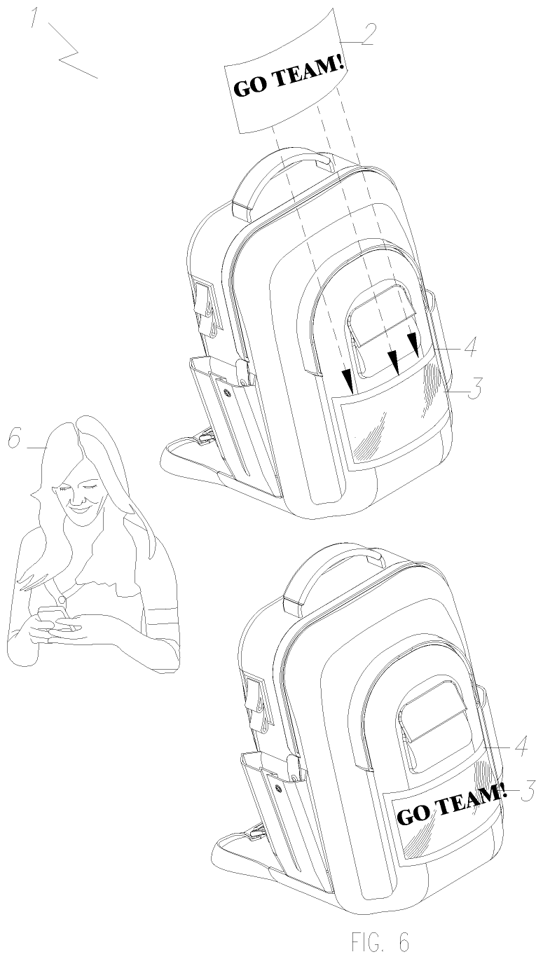

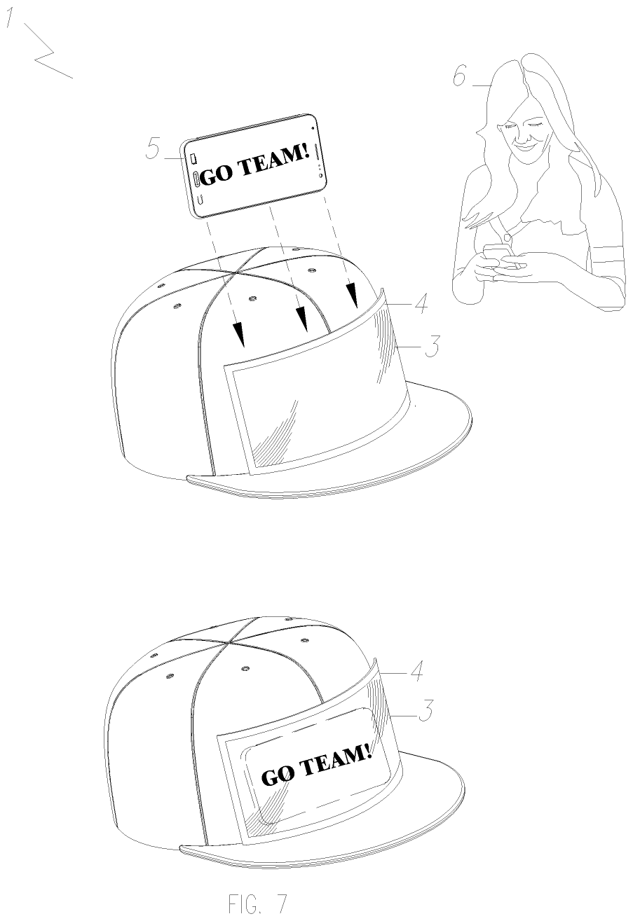

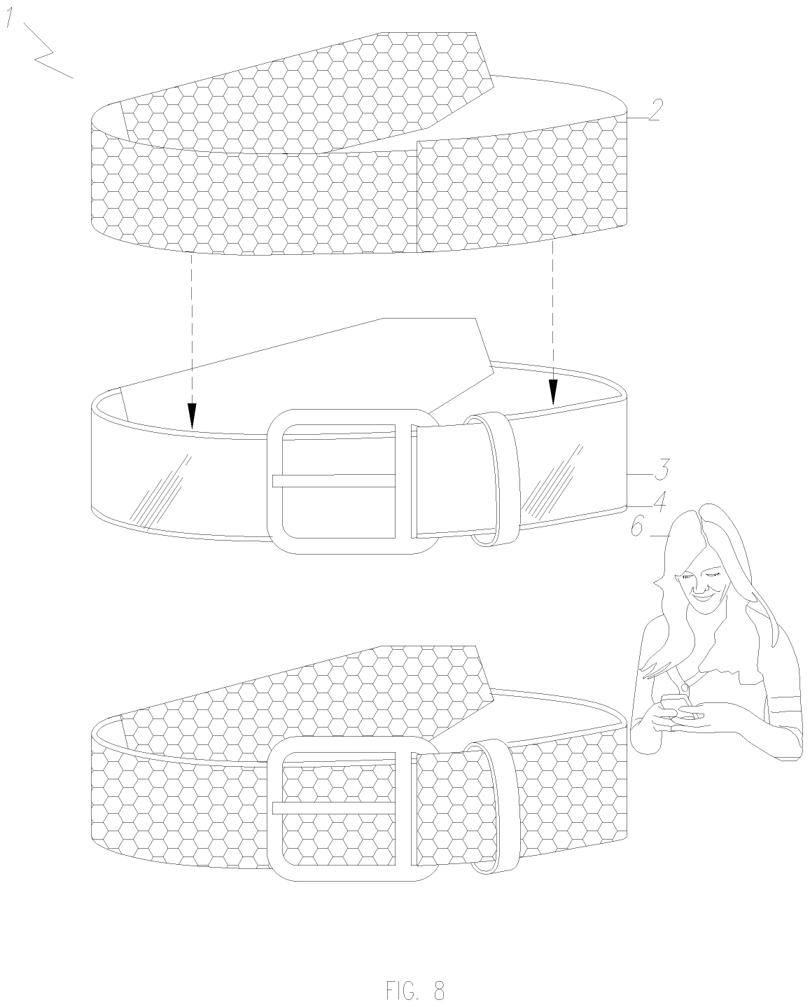

FIG. 3 showing custom card 2 having the shape of a parallelogram and being inserted into a conventional purse. Said custom card 2 having a multitude of shapes and a plurality of colors and relief surfaces thereon. In another embodiment in FIG. 4, the custom cards having the shape of a wristwatch strap. FIG. 6 showing the ICCS 1 being installed on a baseball cap. An affixing mechanism is also disposed on one side of said flexible frame 4 that includes but is not limited to: hooks and loops, double sided tape etc. allowing it to be selectively affixed to multiple substrates manually by a user including but not limited to clothing, fabrics, leather etc. FIG. 7 showing another embodiment of the ICCS 1 being installed on a baseball cap and configured to receive a smart phone with customized digital display message by user 6 therein. FIG. 8 showing the ICCS 1 being installed on a belt. FIG. 4 showing the inventive method of the custom covering system with steps that include but are not limited to: affixing the transparent window onto an item; generating a custom card or digital message; and inserting the custom card or digital image from a mobile device into the transparent window.

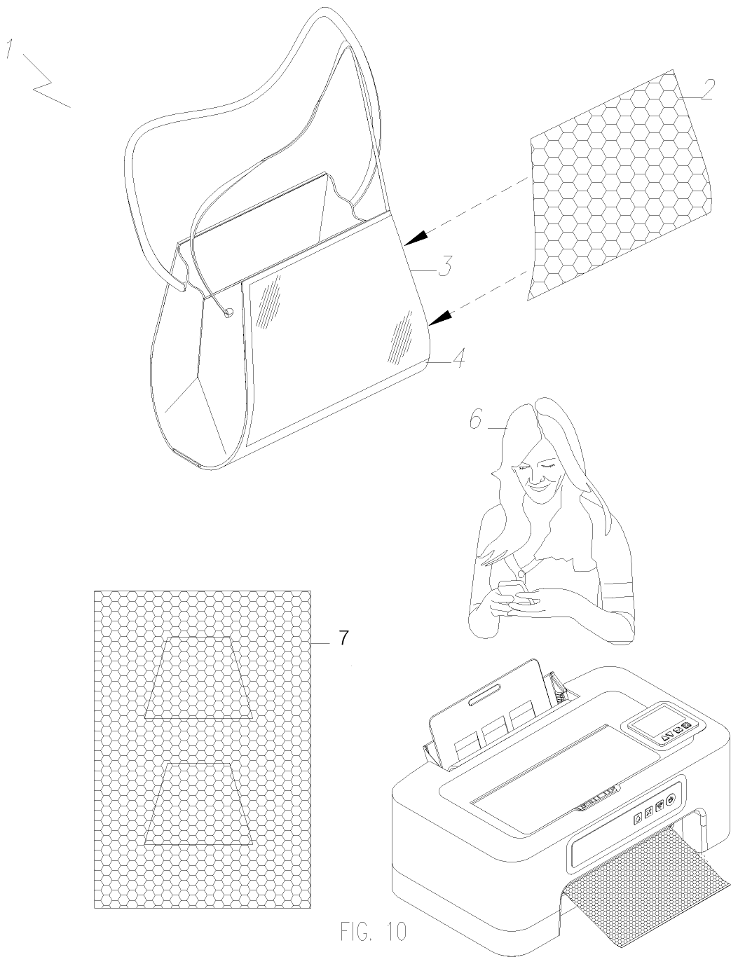

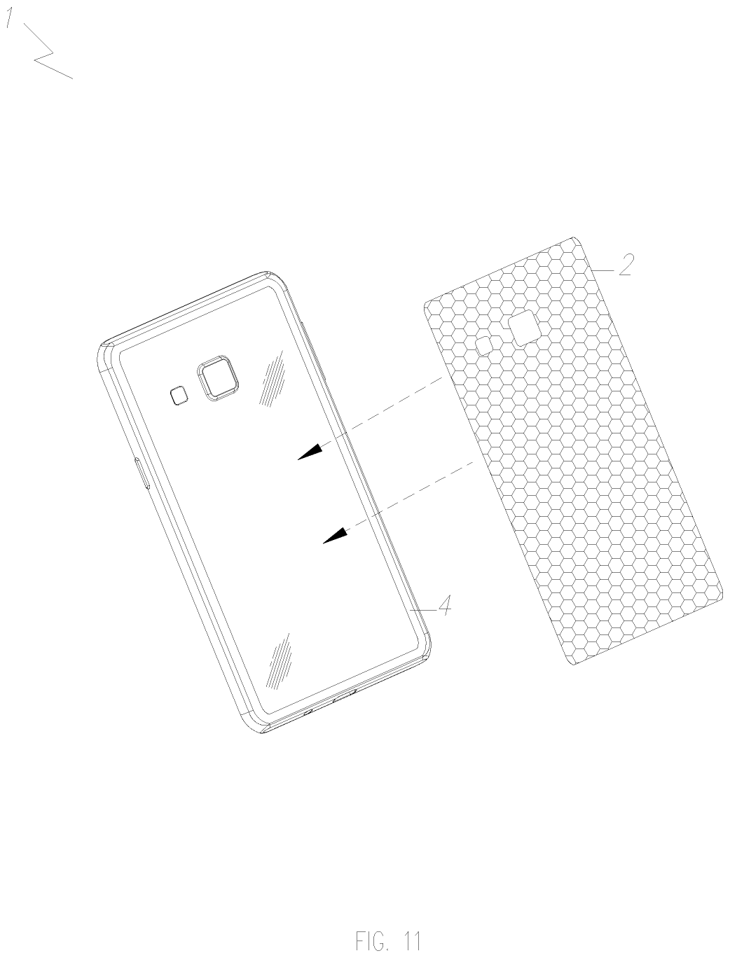

FIG. 10 showing the user 6 interacting with the ICCS 1's mobile software application and having the option of printing a variety of various card inserts with corresponding shapes and dimension to the one or more of the transparent windows on the shoes, back packs, sandals, belts, handbags, hats and the like. The mobile software application having software for generating customized messages and graphics Said cards with patterns, colors and text etc. being created using the mobile software application and being printed using various printers such as commonly available inkjet and laser printers etc. The computer system may be described in the general context of computer system executable instructions, such as program modules, being executed by a computer system. Generally, program modules may include routines, programs, objects, components, logic, data structures, and so on that perform particular tasks or implement particular abstract data types. The computer system may be practiced in distributed cloud computing environments where tasks are performed by remote processing devices that are linked through a communications network. In a distributed cloud computing environment, program modules may be located in both local and remote computer system storage media including memory storage devices. FIG. 11 showing another embodiment of the ICCS 1 having a custom card 2 for insertion into a cell phone case.

It is additionally noted and anticipated that although the device is shown in its most simple form, various components and aspects of the device may be differently shaped or slightly modified when forming the invention herein. As such those skilled in the art will appreciate the descriptions and depictions set forth in this disclosure or merely meant to portray examples of preferred modes within the overall scope and intent of the invention, and are not to be considered limiting in any manner. While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the scope of the invention.

What is claimed is:

1. An interchangeable custom covering system comprising the following parts:
a) a transparent window for displaying customized messages and graphics on personal effects;
b) a custom card used as a substrate for applying customized messages and graphics;
c) a flexible frame for holding the transparent window; and
c) a mobile software application for generating customized messages and graphics.

2. The custom covering system of claim 1, wherein the transparent window having many shapes, colors and textures.

3. The interchangeable custom covering system of claim 1, wherein the transparent window having at least two walls that are sealed within the flexible frame and configured to receive custom the custom card and mobile device therein.

4. The interchangeable custom covering system of claim 1, wherein the transparent window being selectively-detachable, and made of a plastic.

5. The interchangeable custom covering system of claim 1, wherein the transparent window having an affixing mechanism is also disposed on one side allowing it to be selectively-affix to multiple substrates.

6. The interchangeable custom covering system of claim 1, wherein the transparent window and custom card having a plurality of shapes and sizes.

7. The interchangeable custom covering system of claim 1, wherein the mobile software application being on a transitory computer readable medium including computer readable instructions that, when executed by a computer, cause the computer to generate custom text and graphics.

8. A method of displaying custom messaging comprising the following steps:
a) providing the custom covering system of claim 1;
b) affixing the transparent window onto a personal effect;
c) generating a custom card or digital image; and
d) inserting the custom card or digital images into the transparent window.

9. The method of displaying custom messaging of claim 8, wherein the affixing the transparent window;
includes the step of using affixing mechanisms.

10. The method of displaying custom messaging of claim 8, wherein the generating a custom card or digital message is performed using the mobile software application.
